(19) United States
(12) Patent Application Publication
(10) Pub. No.: US 2007/0117554 A1
(43) Pub. Date: May 24, 2007

(54) Wireless handset and methods for use therewith

(76) Inventor: Reed W. Arnos, Austin, TX (US)

Correspondence Address: GARLICK HARRISON & MARKISON, P.O. BOX 160727, AUSTIN, TX, 78716-0727, US

(21) Appl. No.: 11/244,468

(22) Filed: Oct. 6, 2005

(51) Int. Cl. H04Q 7/22; H04L 29/08; H04Q 7/38

(52) U.S. Cl. 455/414.4

(57) ABSTRACT

A wireless handset includes a long range wireless transceiver for sending and receiving wireless data to a wireless telephone network and for selectively producing a first audio stream. An audio playback module selectively produces a second audio stream from a stored audio file. A mixing module produces a mixed audio stream when the first audio stream and the second audio stream are produced contemporaneously. An audio output device produces an audio output based on at least one of: the mixed audio stream, the first audio stream, and the second audio stream.

### CROSS REFERENCE TO RELATED PATENTS

The present application is related to the following U.S. patent applications that are contemporaneously filed and commonly assigned:

Wireless handset and methods for use therewith, having serial number, ______; and

Wireless handset and methods for use therewith, having serial number, ______; the contents of which are expressly incorporated herein in their entirety by reference thereto.

### BACKGROUND OF THE INVENTION

1. Technical Field of the Invention

The present invention relates to wireless handsets used for accessing long range communication networks.

2. Description of Related Art

As is known, wireless handsets are commonly used to access long range communication networks. Examples of such networks include wireless telephone networks that operate cellular, personal communications service (PCS), general packet radio service (GPRS), global system for mobile communications (GSM), and integrated digital enhanced network (iDEN). These networks are capable of accessing the plain old telephone service (POTS) network as well as broadband data networks that provide Internet access and enhanced services such as streaming audio and video, television service, etc., in accordance with international wireless communications standards such as 2G, 2.5G and 3G.

Integrated circuits have enabled the creation of a plethora of handheld devices, however, to be “wired” in today's electronic world, a person needs to posses multiple handheld devices. For example, one may own a cellular telephone for cellular telephone service, a personal digital assistant (PDA) for scheduling, address book, etc., one or more thumb drives for extended memory functionality, a motion picture expert group (MPEG) audio layer 3 (MP3) player for storage and/or playback of digitally recorded music, a radio, etc. Thus, even though a single handheld device may be relatively small, carrying multiple handheld devices on one's person can become quite burdensome.

Therefore, a need exists for wireless handsets that provide greater functionality and features.

### BRIEF DESCRIPTION OF THE SEVERAL VIEWS OF THE DRAWINGS

FIG. 1 presents a pictorial representation of a wireless handset in accordance with an embodiment of the present invention.

FIG. 2 presents a block diagram representation of wireless handset 150 in accordance with an embodiment of the present invention.

FIG. 3 presents a block/pictorial diagram of a host interface 18 in accordance with an embodiment of the present invention.

FIG. 4 presents block/pictorial representation of transceiver module 30 in accordance with an embodiment of the present invention.

FIG. 5 presents a block diagram representation of memory module 40 in accordance with an embodiment of the present invention.

FIG. 6 presents a block/schematic diagram representation of a multimedia module in accordance with an embodiment of the present invention.

FIG. 7 presents a block diagram representation of a multimedia interface 52 in accordance with an embodiment of the present invention.

FIG. 8 presents a block diagram representation of a text message interface 90 in accordance with an embodiment of the present invention.

FIGS. 9-10 present flowchart representations of methods in accordance with embodiments of the present invention.

FIGS. 11-12 present flowchart representations of methods in accordance with embodiments of the present invention.

FIGS. 13-17 present flowchart representations of methods in accordance with embodiments of the present invention.

FIGS. 18-23 present flowchart representations of methods in accordance with embodiments of the present invention.

### DETAILED DESCRIPTION OF THE INVENTION

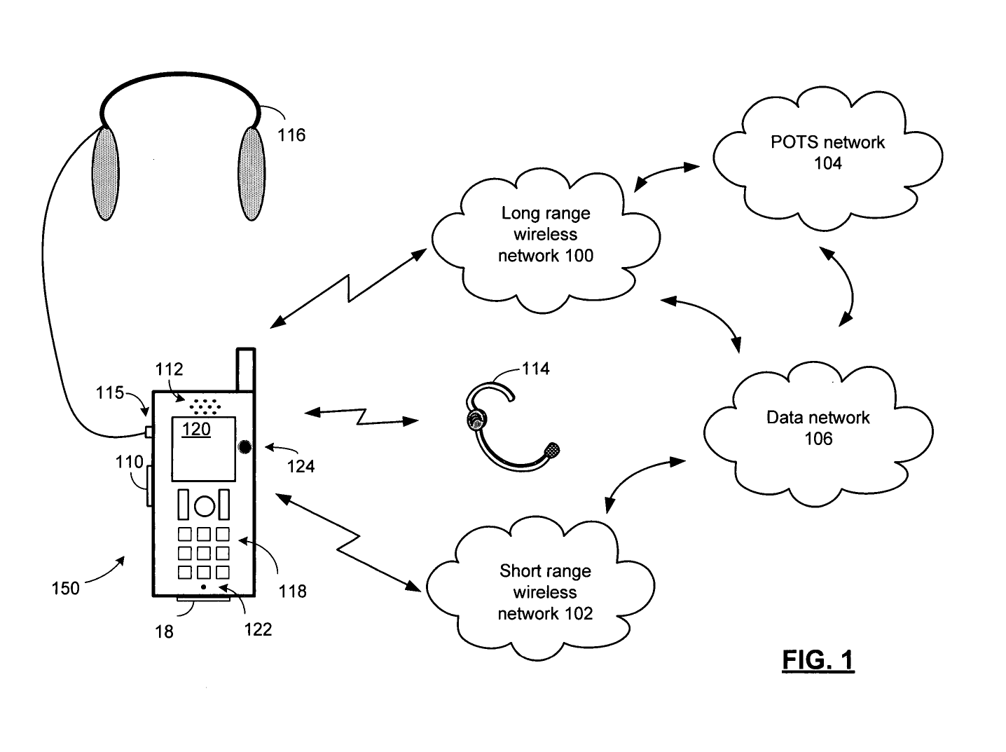

FIG. 1 presents a pictorial representation of a wireless handset in accordance with an embodiment of the present invention. In particular, a wireless handset 150 communicates over a long range wireless network 100 that is operably coupled to the POTS network 104 and data network 106. Wireless handset 150 can further communicate over short range wireless network 102 to data network 106. In an embodiment of the present invention, long range network 100 includes a wireless telephone network such as a cellular, PCS, GPRS, GSM, iDEN or other wireless communications network capable of sending and receiving telephone calls. Further, data network 106 includes the Internet and short range wireless network 102 includes an access point that communicates with the wireless handset 150 via a radio frequency communications link such as 802.11x, Wimax, a wireless local area network connection of other communications link. In this fashion, wireless handset 150 can place and receive telephone calls, text messages such as emails, short message service (SMS) messages, pages and other data messages that may include multimedia attachments such as documents, audio files, video files, images and other graphics.

Wireless handset 150 includes internal audio input device such as microphone 122 and internal audio output device such as speaker 112. In addition, headphones 116 can optionally be connected via headphone jack 115. Wireless headset 114 further includes an audio input device and audio output device that are connected to wireless headset 150 by a short range wireless communications link that uses an infrared link such as IrDA, or a radio frequency communications link conforming to the Bluetooth standard. The user interface of wireless handset 150 includes a keypad 118 and a display device 120 for displaying graphics and text, and optionally providing an additional touch sensitive interface with soft keys and/or graphics input and or handwriting recognition.

Wireless handset optionally includes a camera 124 for capturing still and/or video images, removable memory card 100 for providing additional memory and removable storage, and host interface 18 for uploading and downloading information directly to a host device such as a computer.

The various features and functions of wireless handset 150 will be discussed in conjunction with the figures that follow.

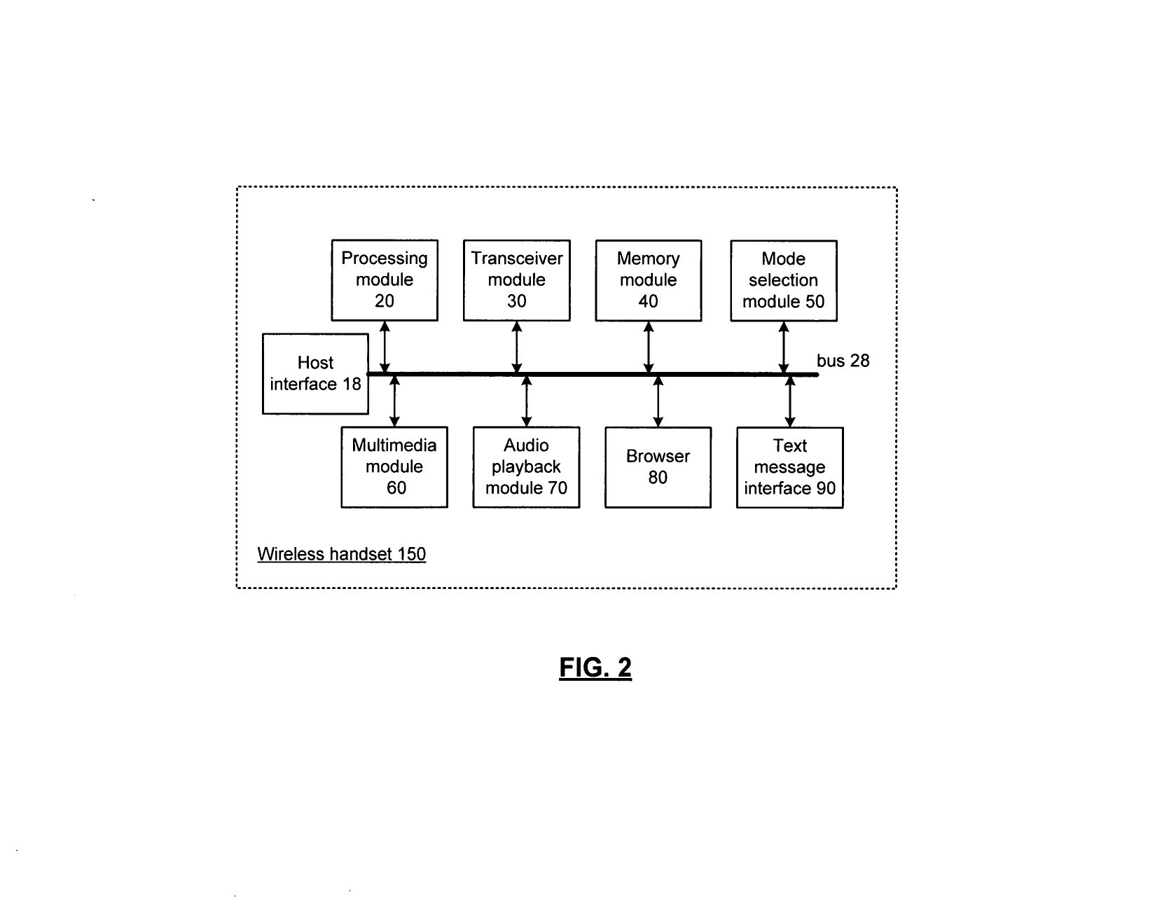

FIG. 2 presents a block diagram representation of wireless handset 150 in accordance with an embodiment of the present invention. In particular, wireless handset 150 includes a processing module 20 and memory module 40 that communicate via bus 28. In an embodiment of the present invention, processing module 20 includes a processor for executing a series of operational instructions such as system programs, application programs, and other routines.

The processor of processing module 20 can be implemented using a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in memory. Note that when the processing module 20 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. Further note that, the memory module 40 stores, and the processing module 20 executes, operational instructions corresponding to at least some of the steps and/or functions illustrated herein.

The memory module 40 may be a single memory device or a plurality of memory devices. Such a memory device may be a read-only memory, random access memory, volatile memory, non-volatile memory, static memory, dynamic memory, flash memory, cache memory, and/or any device that stores digital information.

In addition, wireless handset 150 includes host interface 18, a text message interface 90 for providing a user interface for retrieving, selecting and composing text messages, a transceiver module 30 that includes one or more transceivers, a mode selection module 50 for placing the wireless handset 150 in one or more operating modes, a multimedia module 60 for processing input and output, an audio playback module 70 for processing audio output, and a browser 80 for providing a user interface for Internet access and similar content for accessing streaming audio and streaming video content, and for downloading data files such as may be text files, presentation files, user profile information for access to varies computer services (e.g., Internet access, email, etc.), digital audio files (e.g., MP3 files, WMA—Windows Media Architecture-, mp3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format.

Each of these modules may be implemented in hardware, firmware, software or a combination thereof, in accordance with the broad scope of the present invention. While a particular bus architecture is shown in FIG. 2, alternative bus architectures that include further connectivity, such as direct connectivity between the various modules, are likewise possible to implement the features and functions included in the various embodiments of the present invention.

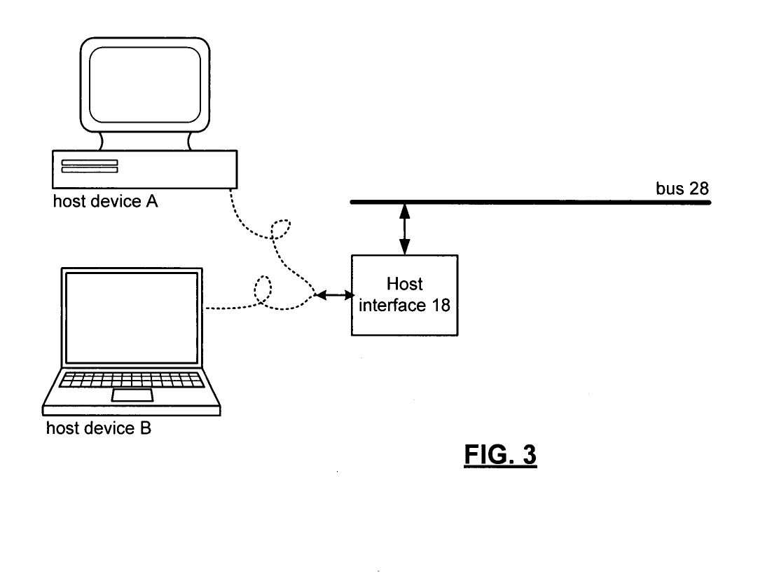

FIG. 3 presents a block/pictorial diagram of a host interface 18 in accordance with an embodiment of the present invention. In particular, the operation of wireless handset is described when optional host interface 18 is included. When the wireless handset 150 is operably coupled to a host device A, or B which may be a personal computer, workstation, server (which are represented by host device A), a laptop computer (host device B), a personal digital assistant and/or any other device that may transceive data with the multi-function handheld device, the mode selection module 50 places the integrated circuit 12 in a host connected mode.

With the wireless handset 150 is in the host connected mode, the host interface 18 facilitates the transfer of data between the host device A or B and wireless handset 150. For example, data received from the host device A, or B is first received via the host interface 18. Depending on the type of coupling between the host device and the wireless handset 150, the received data will be formatted in a particular manner. For example, if the wireless handset is coupled to the host device via a USB cable, the received data will be in accordance with the format proscribed by the USB specification. The host interface 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided to memory module 40 for storage. In this mode, the wireless handset 150 is functioning as extended memory of the host device (e.g., like a thumb drive).

In furtherance of the host connected mode, the host device may retrieve data from memory module 40 as if the memory were part of the computer. Accordingly, the host device provides a read command to the wireless handset 150, which is received via the host interface 18. The host interface 18 converts the read request into a generic format and provides the request to the processing module 20. The processing module 20 interprets the read request and coordinates the retrieval of the requested data from memory module 40. The retrieved data is provided to the host interface 18, which converts the format of the retrieved data from the generic format of the wireless handset 150 into the format of the coupling between the wireless handset and the host device. The host interface 18 then provides the formatted data to the host device via the coupling.

The coupling between the host device and the wireless handset 150 may be a wireless connection or a wired connection. For instance, a wireless connection, provided by transceiver module 30 may be in accordance with Bluetooth, IEEE 802.11x, and/or any other wireless LAN (local area network) protocol, IrDA, etc. The wired connection may be in accordance with one or more Ethernet protocols, Firewire, USB, etc. Depending on the particular type of connection, the host interface 18 includes a corresponding encoder and decoder. For example, when the wireless handset 150 is coupled to the host device via a USB cable, the host interface 18 includes a USB encoder and a USB decoder.

As one of average skill in the art will appreciate, the data stored in memory module, which may have 64 Mbytes or greater of storage capacity, may be text files, presentation files, user profile information for access to varies computer services (e.g., Internet access, email, etc.), digital audio files (e.g., MP3 files, WMA—Windows Media Architecture-, mp3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format.

In an embodiment of the present invention, when the wireless handset 150 is coupled to the host device A or B via a wired connection or direct coupling, the host device may power the wireless device 150 such that the battery is unused and/or may further recharge the battery of wireless device 150. When the wireless handset 150 is uncoupled from the host device, the mode selection module 50 detects the disconnection and places the wireless handset in an alternative operational mode.

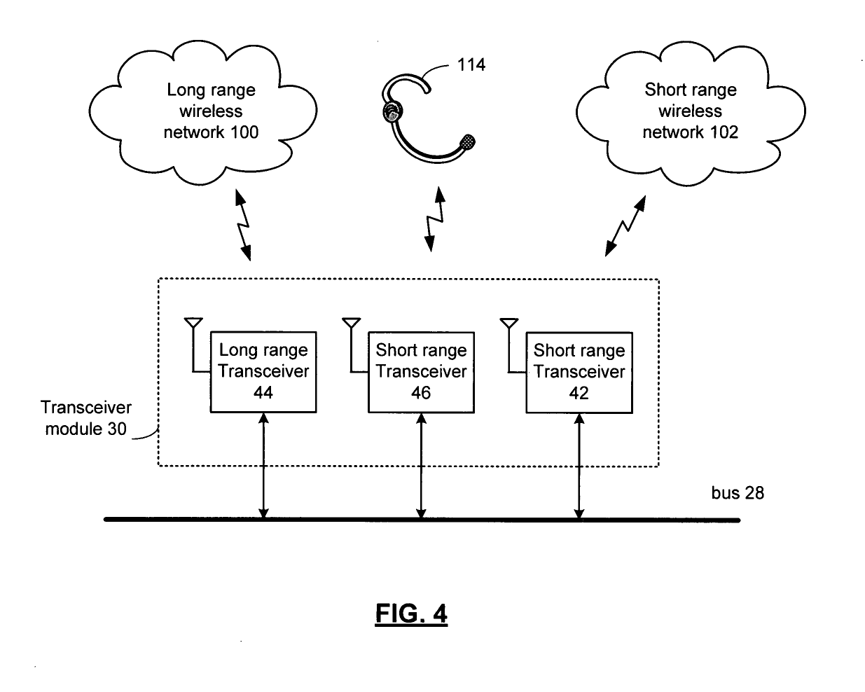

FIG. 4 presents block/pictorial representation of transceiver module 30 in accordance with an embodiment of the present invention. In an embodiment of the present invention, transceiver module 30 includes long range transceiver 44, and short range transceivers 42 and 46. Long range transceiver 44 provides access to long range wireless network 100, short range transceiver 42 provides access to short range wireless network 102 and short range transceiver 46 provides access to wireless peripheral devices such as host A or B when host interface 18 is implemented with a wireless connection, wireless headset 114, a wireless keyboard or other peripheral devices.

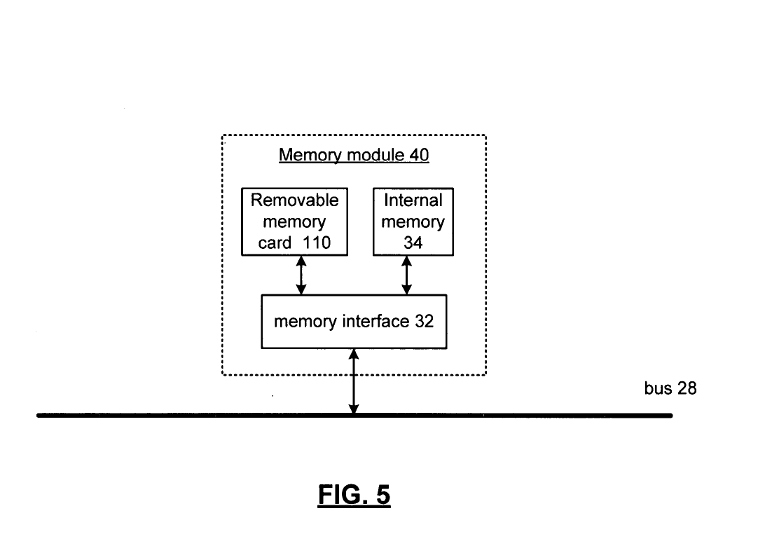

FIG. 5 presents a block diagram representation of memory module 40 in accordance with an embodiment of the present invention. In particular, memory module 40 includes a memory interface 32 for accessing an internal memory 34 and removable memory card 110. In an embodiment of the present invention, removable memory card 110 can include non-volatile memory in a format such as CompactFlash, SmartMedia, Memory Stick, Secure Digital (SD) card, xD card or other memory card format. In an embodiment of the present invention, removable memory card 110 can store data such as text files, presentation files, user profile information for access to varies computer services (e.g., Internet access, email, etc.), digital audio files (e.g., MP3 files, WMA—Windows Media Architecture-, mp3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format.

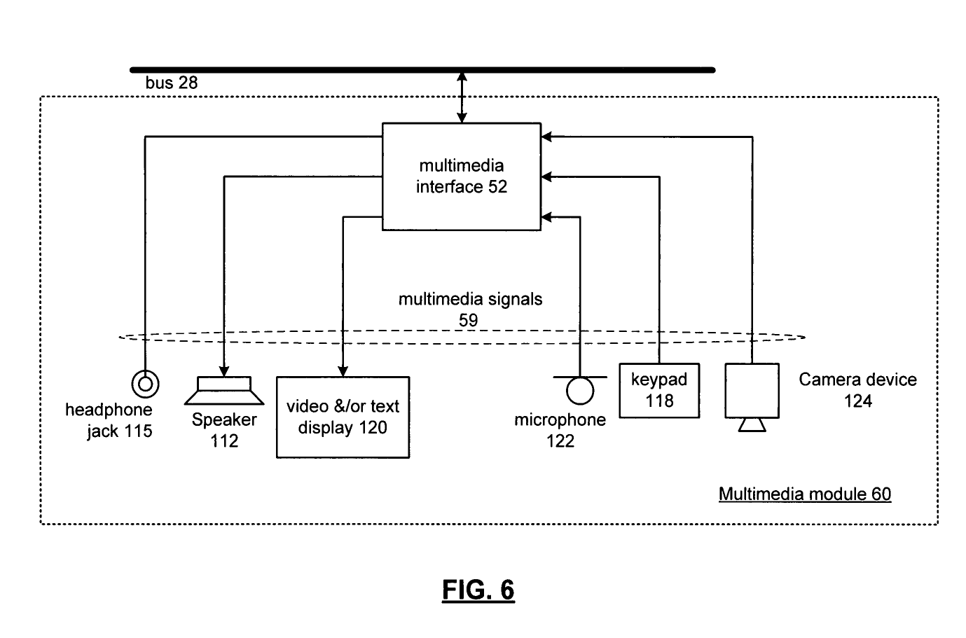

FIG. 6 presents a block/schematic diagram representation of a multimedia module in accordance with an embodiment of the present invention. In particular, multimedia module 60 includes a multimedia interface 52 for providing multimedia signals to and from a variety of input/output devices including headphones 116 via headphone jack 115, speaker 112, video and/or text display 120, microphone 122, keypad 118 and camera device 124. These multimedia signals 59 may be analog signals, discrete time signals, or digital signals depending on particular form and format used by each device.

FIG. 7 presents a block diagram representation of a multimedia interface 52 in accordance with an embodiment of the present invention. In particular, multimedia interface 52 provides digital to analog conversion, analog to digital conversion, formats output signals sent to output devices of multimedia module 60 and processes input signals for coding, compression, storage and further processing by the various submodules of multimedia interface 52 and by the other modules of wireless handset 150. The submodules of multimedia interface 52 optionally include one or more of the following: a vocoder 200 for digitizing voice signals, a video codec 202 for digitizing video signals, an audio compressor 204 for creating compressed audio files, a mixing module 206 for mixing two or more audio streams, a video compressor 208 for creating compressed video files, an image compressor 210 for creating compressed image files, a text-to speech conversion module 212 for converting text data into to synthesized voice signals, and a speech recognition module 214 for recognizing the content of speech such as one or more spoken commands.

In an embodiment of the present invention under the control of the processing module 20, the multimedia module 60 retrieves multimedia data from memory module 40. The multimedia data includes at least one of digitized audio data, digital video data, and text data. In a playback mode, upon retrieval of the multimedia data, the multimedia module 60 converts the data into output data. For example, the multimedia module 60 may convert digitized data into analog signals that are subsequently rendered audible via a speaker or via a headphone jack. In addition, or in the alternative, the multimedia module 60 may render digital video data and/or digital text data into RGB (red-green-blue), YUV, etc., data for display on an LCD (liquid crystal display) monitor, projection CRT, and/or on a plasma type display, such as display 120.

In a storage mode, the wireless handset 150 may store digital information received via one of the input devices 118, 122 and 124. For example, a voice recording received via the microphone 122 may be digitized via the multimedia module 60 and digitally stored in memory module 40. Similarly, video recordings may be captured via the camera device 124 (e.g., a digital camera, a camcorder, VCR output, DVD output, etc.) and processed by the multimedia module 60 for storage as digital video data in memory module 40. Further, the keypad 118 (which may be a keyboard, touch screen interface, or other mechanism for inputting text information) provides text data to the multimedia module 60 for storage as digital text data in memory module 40

As will be understood by one skilled in the art when presented the disclosure herein, the multimedia module 60 may include less than the components shown in FIGS. 6 and 7. For instance, the multimedia module 60 may process audio, but not video data, or vice versa. Further, the multimedia module 60 can include further coding, decoding, formatting, encryption, decryption and signal processing modules than are specifically shown. In addition, multimedia module 60 can be implemented with audio and video inputs, in addition to the inputs that are expressly illustrated.

In operation, the wireless handset 150 includes a transceiver module, such as transceiver module 30 for receiving a first text message. A mode selection module, such as mode select module 50, places the wireless handset 150 in a text playback mode in response to a text playback signal. A text to speech conversion module, such as text to speech conversion module 214 converts text information from the first text message into a first audio stream when the handset is in the text playback mode. An audio output device, such as speaker 112, headset 114 and headset 116, is operable coupled to the text to speech conversion module for converting the first audio stream into a first audio output. In this fashion, a user may listen to text messages while engaged in other tasks, without the need to be looking at a text display such as display device 120.

In an embodiment of the present invention, the text playback signal is generated by speech recognition module 214 in response to recognizing a spoken text playback mode command of a user received from an audio input device such as microphone 122. In this fashion, a user may select this mode of operation in a hands-free way. In an alternative embodiment of the present invention a user interface of wireless handset 150, such as keypad 118 is used to generate the text playback signal in response to a user selecting the text playback mode. In a further embodiment, a text message interface, such as text message interface 90, is operably coupled to the mode selection module 50. Mode selection module 50 automatically places the wireless handset 150 in the text playback mode in response to a user selecting the first text message. In an embodiment of the present invention, the mode selection module 50 automatically places the wireless handset 150 in the text playback mode in response to the receipt of the first text message.

In an embodiment of the present invention, the wireless handset 150 can generate an audio stream that includes a query to listen to a received text message. This query can be a prestored audio file or generated by text to speech conversion, such as by text to speech conversion module 212 or a combination thereof. In an embodiment of the present invention, this query can include a first audio stream derived from text to speech conversion of the header information including further preprocessing to convert names, dates, and subject information from the text message into words that can be spoken. For example, the query may contain one of the statements below in response to a first message from william_shakespeare@pirodigy.net having a subject line “How about those Washington Senators” sent on Jan. 1 2005.

“You have received a new text message. Would you like to listen to it now? If so, say yes or press 1 to continue”

“You have received a new text message from william_shakespeare@prodigy.net. Would you like to listen to it now?”

“You have received a new text message from william_shakespeare@prodigy.net regarding, How about those Washington Senators. Would you like to listen to it now? If so, press 1 to continue”

“You received a text message today from William Shakespeare. Would you like to listen to it now? If so, press 1 to continue”

In response, the user may press a button of keypad 118, a soft key of display 120 or otherwise provide a further indication such as a spoken command recognized by speech recognition module 214, that commands the text message interface 90 to open the received text message and to convert the text in the received text message into the first audio stream, such as by text to speech conversion module 212.

In further operation, transceiver module 30 is capable of receiving a plurality of text messages, wherein a first text message of the plurality of received text messages includes a compressed audio file, such as a file that is stored in an MPEG file format or a wave file format or other file format. A mode selection module, such as mode selection module 50, can place the wireless handset in an audio attachment playback mode. An audio playback module such as audio playback module 70 converts the compressed audio file into a first audio signal stream when the wireless handset is in the audio attachment playback mode. An audio output device, such as speaker 112, headset 114 and headset 116, converts the first audio stream into a first audio output.

In an embodiment of the present invention, the audio attachment playback signal is generated by speech recognition module 214 in response to recognizing a spoken audio attachment playback mode command of a user received from an audio input device such as microphone 122. In this fashion, a user may select this mode of operation in a hands-free way. In an alternative embodiment of the present invention a user interface of wireless handset 150, such as keypad 118 is used to generate the audio attachment playback signal in response to a user selecting the audio attachment playback mode. In a further embodiment, a text message interface, such as text message interface 90, is operably coupled to the mode selection module 50. Mode selection module 50 automatically places the wireless handset 150 in the audio attachment playback mode in response to a user selecting the first text message. In an embodiment of the present invention, the mode selection module 50 automatically places the wireless handset 150 in the audio attachment playback mode in response to the receipt of the first text message.

The wireless handset 150 can generate an audio stream that includes a query to listen to a received audio attachment. This query can be a prestored audio file or generated by text to speech conversion, such as by text to speech conversion module 212 or a combination thereof. In an embodiment of the present invention, this query can include a first audio stream derived from text to speech conversion of the header information or the header information including further preprocessing to convert names, dates, and subject information from the text message into words that can be spoken. For example, the query may contain one of the statements below in response to a first message from william_shakespeare@prodigy.net having a subject line “How about those Washington Senators” sent on Jan. 1 2005.

“You have received a new text message with a voice message attached. Would you like to listen to the voice message new? If so, say yes or press 1 to continue”

“You have received an audio file from william_shakespeare@prodigy.net. Would you like to listen to it now?”

“You have received a new message from william_shakespeare@prodigy.net regarding, How about those Washington Senators. Would you like to listen to the attached audio file now? If so, press 1 to continue”

“You received a text message today with an attached audio file from William Shakespeare. Would you like to listen to it now? If so, press 1 to continue”

In response, the user may press a button of keypad 118, a soft key of display 120 or otherwise provide a further indication, such as a spoken command recognized by speech recognition module 214, that commands the text message interface 90 to open and playback the received audio file.

In further operation, a long range wireless transceiver such as long range transceiver 44 sends and receives wireless data to a wireless telephone network, such as long range wireless network 100. The long range wireless transceiver selectively produces a first audio stream. An audio playback module, such as audio playback module 70 selectively produces a second audio stream from a stored audio file. A mixing module, such as mixing module 206 is operably coupled to the long range transceiver and the audio playback module, and produces a mixed audio stream when the first audio stream and the second audio stream are produced contemporaneously. An audio output device, such as speaker 112, headset 116 and headset 114 (via short range wireless transceiver, such as short range transceiver 46) produce an audio output based on at least one of: the mixed audio stream, the first audio stream, and the second audio stream.

In accordance with an embodiment of the present invention, the audio playback module includes an audio player such as an MP3 player for processing the storage and/or playback of the digitally formatted audio data such as songs, audio books, audio clips or educational materials. When a user listens to the playback of an audio file that is stored in memory module 40, audio signals generated by the long range wireless transceiver are mixed with the audio playback to allow the user to hear both audio streams. In an alternative embodiment of the present invention, audio playback module processes the playback of an audio channel derived from a streaming audio signal, or a streaming video signal from a file that is stored remotely from the wireless handset 150. In a further embodiment of the present invention, audio playback module processes the playback of an audio channel derived from a video signal from a file containing video content such as a movie, home video, video clip, or video file captured by wireless handset 150, that is stored in memory module 40. The second audio stream may further be the first audio stream discussed in conjunction with playback of text messages and audio file attachments. The terms first audio stream and second audio stream can be used interchangeably to represent two different audio streams that are present contemporaneously, regardless of the source.

In an embodiment of the present invention, the first audio stream is a ringtone, audible caller ID information, a low battery indicator, voicemail received indictor, text message received indicator or other status indicator. In the case of a ringtones, low battery indicators, voicemail and text message received indicators or other status indicators, the particular sounds corresponding to the first audio stream can be selected by the user from a plurality of prestored sounds in memory module 40, or can be downloaded by the user and stored in memory module 40. In the case of audible caller ID information, the caller ID information in text form is received from long range wireless network 100 is optionally preprocessed to generate speakable text and is translated into a first audio stream by text to speech conversion, such as by text to speech conversion module 212.

In response to a ringtone or audible caller ID information, the user may press a button of keypad 118, a soft key of display 120 or otherwise provide a further indication, such as a spoken command recognized by speech recognition module 214, to command the audio playback module to suspend the second audio stream in response to a user selection to accept a call. In an embodiment of the present invention, suspending the second audio stream includes pausing the playback at a particular point in the second audio stream such that playback can be later resumed at that point or at substantially that point. In an alternative embodiment of the present invention, the second audio stream can be otherwise suspended such as by stopping the playback such that continuing playback begins at the beginning of the second audio stream or at some other intermediate point. Further, the audio playback module can automatically continue the second audio stream in response to a user selection to end the call, such as when the user presses an “end call” button of keypad 118 or provides a spoken command recognized by speech recognition module 214 or when a call ends due to network failure or when the other party terminates the call. In the alternative, in response to the ringtone, audible caller ID information, low battery indicator or other status indicator the user may press a button of keypad 118, a soft key of display 120 or otherwise provide a further indication to discontinue playback of the first audio stream while continuing playback of the second audio stream.

In an alternative embodiment of the present invention, in response to a ringtone or audible caller ID information, the user may press a button of keypad 118, a soft key of display 120 or otherwise provide a further indication, such as a spoken command recognized by speech recognition module 214, that commands the mixing module to attenuate the volume of the second audio stream in response to a user selection to accept a call. Further, the mixing module can automatically boost the volume of the second audio stream, such as to compensate for the attenuation of the second audio stream, in response to a user selection to end the call, such as when the user presses an “end call” button of keypad 118 or provides a spoken command recognized by speech recognition module 214214 or when a call ends due to network failure or when the other party terminates the call. In this fashion, the user can continue listening to the second audio stream, in an attenuated form, during the call. In an embodiment of the present invention, whether the audio playback module suspends the second audio stream or the mixing module attenuates the second audio stream during the duration of a call can be an option, selectable by the user and stored in a preferences file in memory module 40.

In an embodiment of the present invention, the first audio stream includes a query to listen to a received voicemail message. This query can be a prestored audio file or generated by text to speech conversion, such as by text to speech conversion module 212. In response, the user may press a button of keypad 118, a soft key of display 120 or otherwise provide a further indication, such as a spoken command recognized by speech recognition module 214, that commands the long range wireless transceiver to launch a call to voicemail to retrieve the voicemail message. In this instance, the audible playback module can suspend the playback of the second audio stream or the mixing module can attenuate the volume of the second audio stream as previously discussed, during the duration of the call.

In an embodiment of the present invention, the first audio stream includes a query to listen to an audio file received as a message, such as an audio file attachment to a received text message. This query can be a prestored audio file or generated by text to speech conversion, such as by text to speech conversion module 212. In response, the user may press a button of keypad 118, a soft key of display 120 or otherwise provide a further indication, such as a spoken command recognized by speech recognition module 214, that commands the text message interface 90 to open and playback the received audio. In this instance, the audible playback module can suspend the playback of the second audio stream or the mixing module can attenuate the volume of the second audio stream as previously discussed, during the playback of the received audio file.

In an embodiment of the present invention, the first audio stream includes a query to listen to a received text message. This query can be a prestored audio file or generated by text to speech conversion, such as by text to speech conversion module 212. In an embodiment of the present invention, this query can include a first audio stream derived from text to speech conversion of the header information from the text message as previously discussed. In response, the user may press a button of keypad 118, a soft key of display 120 or otherwise provide a further indication, such as a spoken command recognized by speech recognition module 214, that commands the text message interface 90 to launch a open the received text message and to convert the text in the received text message into the first audio stream, such as by text to speech conversion module 212. In this instance, the audible playback module can suspend the playback of the second audio stream or the mixing module can attenuate the volume of the second audio stream as previously discussed, during the playback of the received text message.

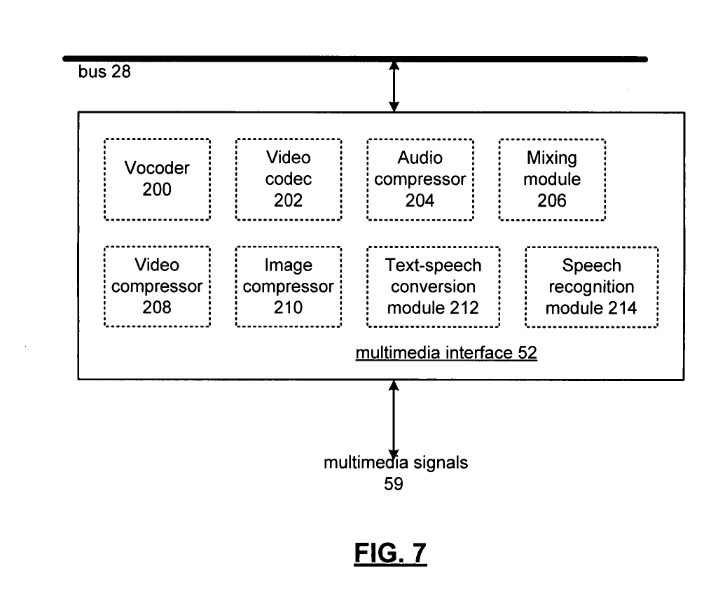

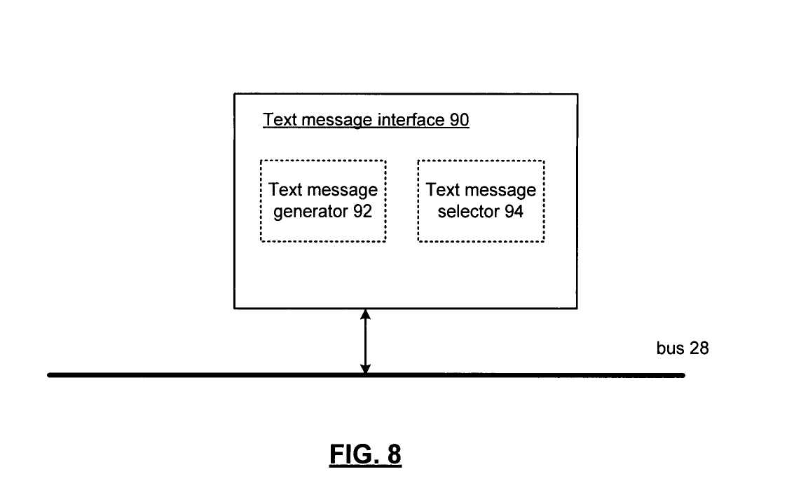

FIG. 8 presents a block diagram representation of a text message interface 90 in accordance with an embodiment of the present invention. In particular, text message interface 90 includes a text message generator 92 that allows a user to compose a text message, and a text message selector 94 that allows a user to select one or more text messages that have been received. In an embodiment of the present invention, text message interface 90 includes an inbox folder, sent message folder, draft message folder, trash folder, and addresses folder that allow a user to receive, review, forward and reply to a text message that is received and to draft, edit, address, and attach files to a text message that is sent.

In operation, wireless handset 150 includes a mode selection module, such as mode selection module 50, for placing the wireless handset in a voice record mode in response to a voice record mode signal. A vocoder module, such as vocoder 200, digitizes and stores a voice message as a compressed voice message file, when the wireless handset is in the voice record mode. Text message generator 92 can generate a text message based on text message address data, the text message including the compressed voice message file. A transceiver module, such as transceiver module 30 transmits the text message. In an embodiment of the present invention, the voice record mode signal is generated by a speech recognition module, such as speech recognition module 214, in response to recognizing a spoken voice record mode command of a user. This allows a user to generate and send text messages in a hands free mode to compatible devices, without having to enter text on a keyboard or other device.

In an embodiment of the present invention, speech recognition module 214 generates text message address data in response to spoken text message voice commands from the user. In particular, speech recognition module 214 is operably coupled to a plurality of stored addresses, stored in memory module 40. In an embodiment, user creates these stored addresses via text input and the handset creates voice templates corresponding these addresses in a voice training mode. In operation, speech recognition module 214 generates the text message address data, such as william_shakespeare@prodigy.net, by recognizing an address command corresponding to one of the plurality of stored addresses that corresponds to the voice template created in training, such as “William Shakespeare”. While a speaker dependent speech recognition algorithm has been described above, other algorithms including speaker independent speech recognition algorithms could likewise be used in the implementation of speech recognition module 214.

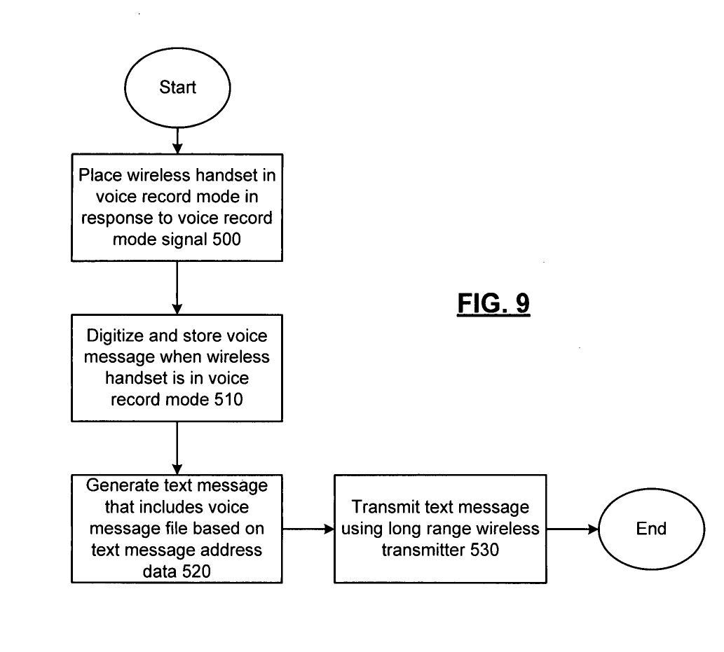

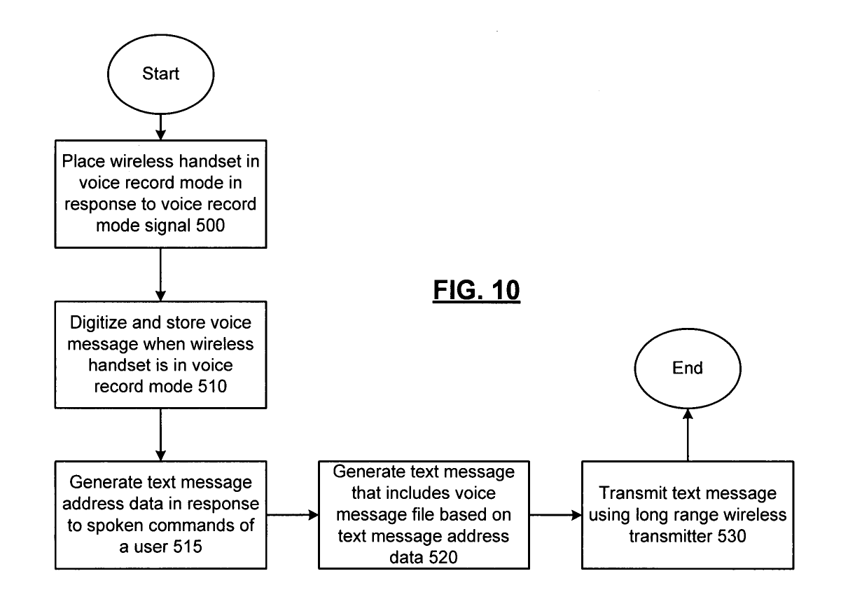

FIGS. 9-10 present flowchart representations of methods in accordance with embodiments of the present invention. In particular, these methods can be used in conjunction with the embodiments of the present invention described in conjunction with FIGS. 1-8. The method begins in step 500 by placing a wireless handset in a voice record mode in response to a voice record mode signal. In step 510, a voice message is digitized and stored as a compressed voice message file, when the wireless handset is in the voice record mode. In step 520, a text message is generated based on text message address data, the text message including the compressed voice message file. In step 530, the text message is transmitted using a long range wireless transceiver. In a further embodiment, step 515 of generating text message address data in response to spoken text message voice commands from the user, is added.

FIGS. 11-12 present flowchart representations of methods in accordance with embodiments of the present invention. In particular, these methods can be used in conjunction with the embodiments of the present invention described in conjunction with FIGS. 1-10. The method begins in step 550 by receiving a plurality of text messages, wherein at least one of the plurality of received text messages includes a compressed audio file. In step 554, the wireless handset is placed in an audio attachment playback mode. In step 558, the compressed audio file is converted into a first audio signal stream when the wireless handset is in the audio attachment playback mode and in step 570 the first audio stream is converted into a first audio output. In a further embodiment, step 562 of converting text information from the at least one of the plurality of text messages into a second audio stream and converting the second audio stream to a second audio output and step 566 of transmitting the first audio stream to the audio output device using a short range wireless transceiver are both added.

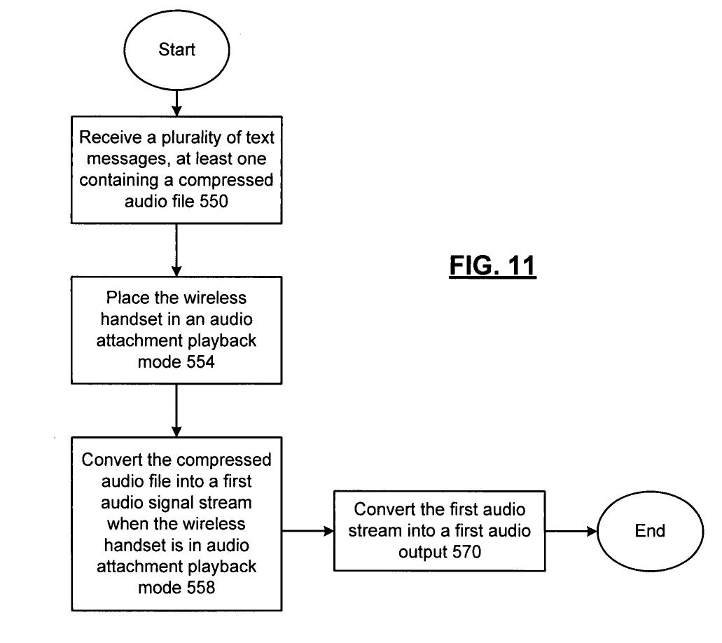

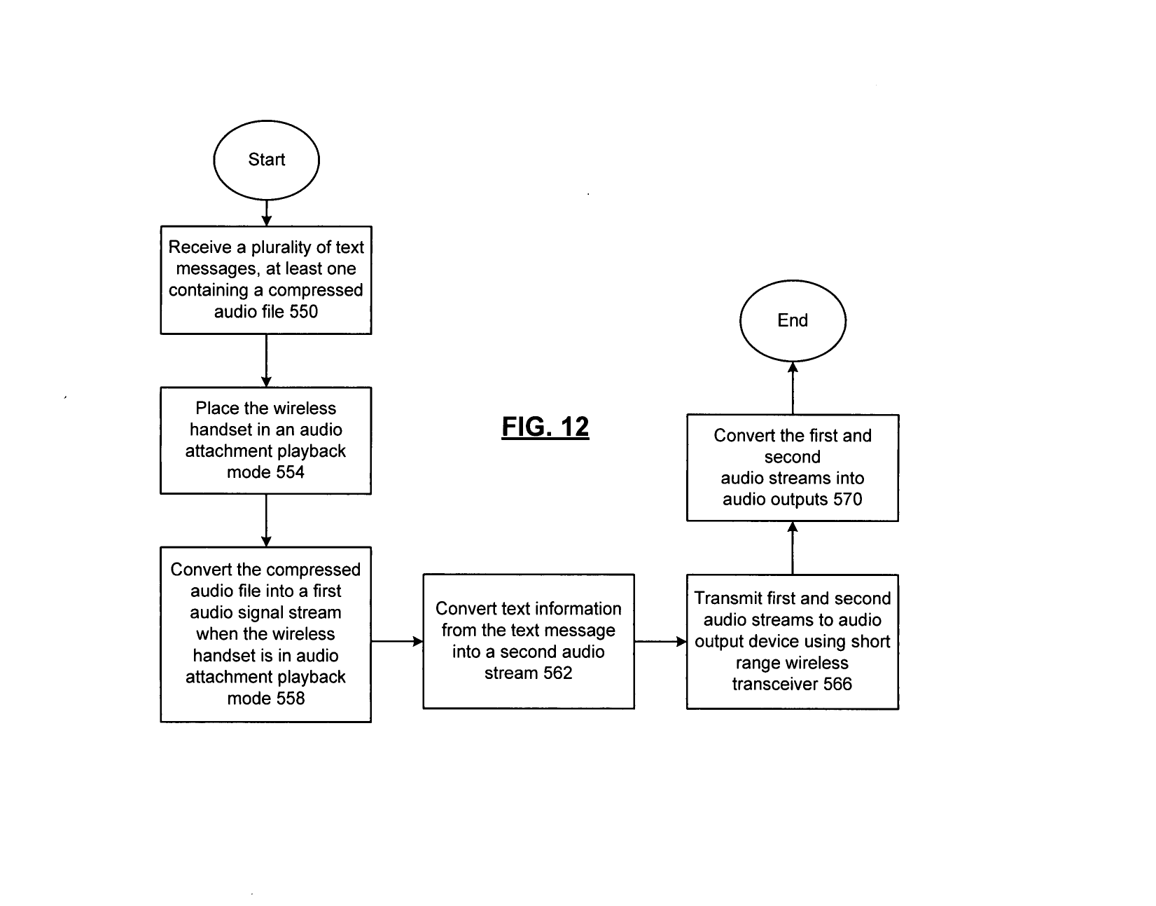

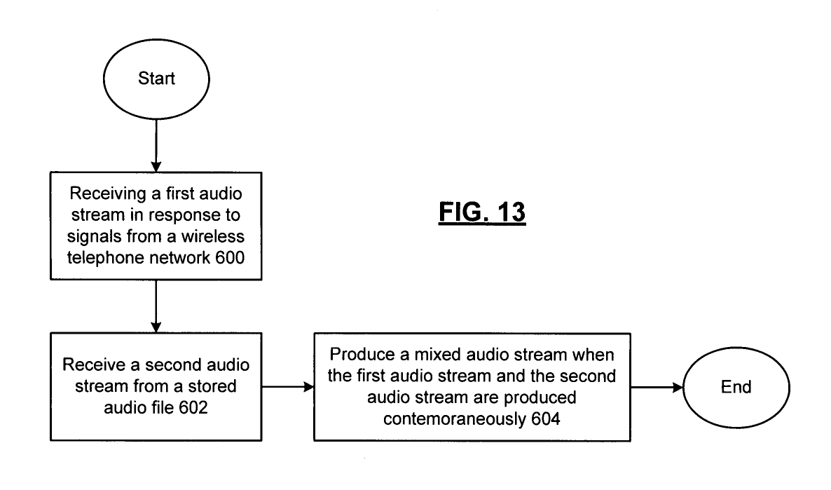

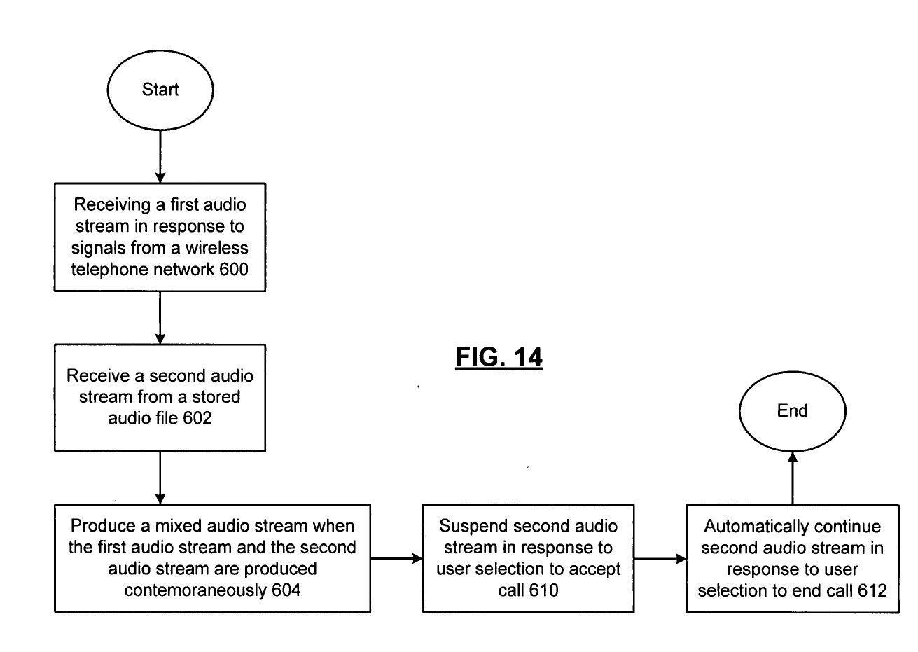

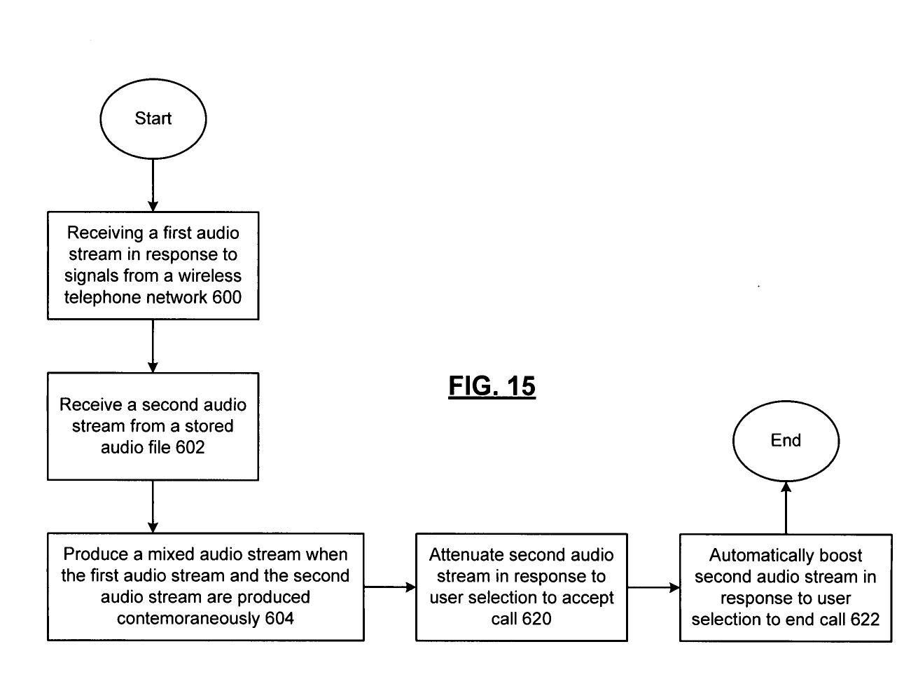

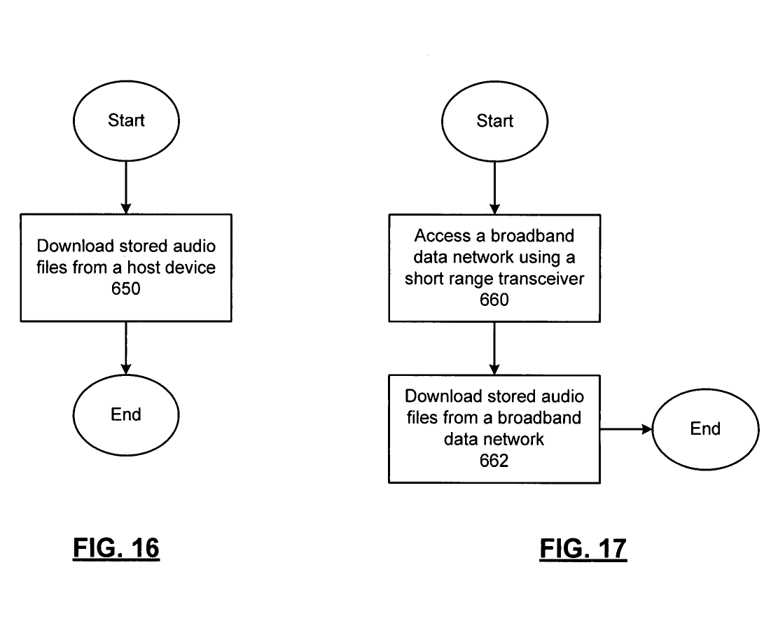

FIGS. 13-17 present flowchart representations of methods in accordance with embodiments of the present invention. In particular, these methods can be used in conjunction with the embodiments of the present invention described in conjunction with FIGS. 1-12. The method begins in step 600 by receiving a first audio stream in response to signals from a wireless telephone network, such as from call, text message, voicemail message, etc. In step 602, a second audio stream is received from a stored audio file. In step 604, a mixed audio stream is produced when the first audio stream and the second audio stream are produced contemporaneously. In a further embodiment of the present invention, step 610 of suspending the second audio stream in response to a user selection to accept the call and step 612 of automatically continuing the second audio stream in response to a user selection to end the call, are added. In an alternative embodiment, step 620 of attenuating a volume of the second audio stream in response to a user selection to accept the call, and step 622 of boosting the volume of the second audio stream in response to a user selection to end the call, are added. Also, step 650 includes downloading stored audio files from a host device. Step 660 includes accessing a broadband network using a short range transceiver and step 662 includes downloading stored audio files from the broadband data network.

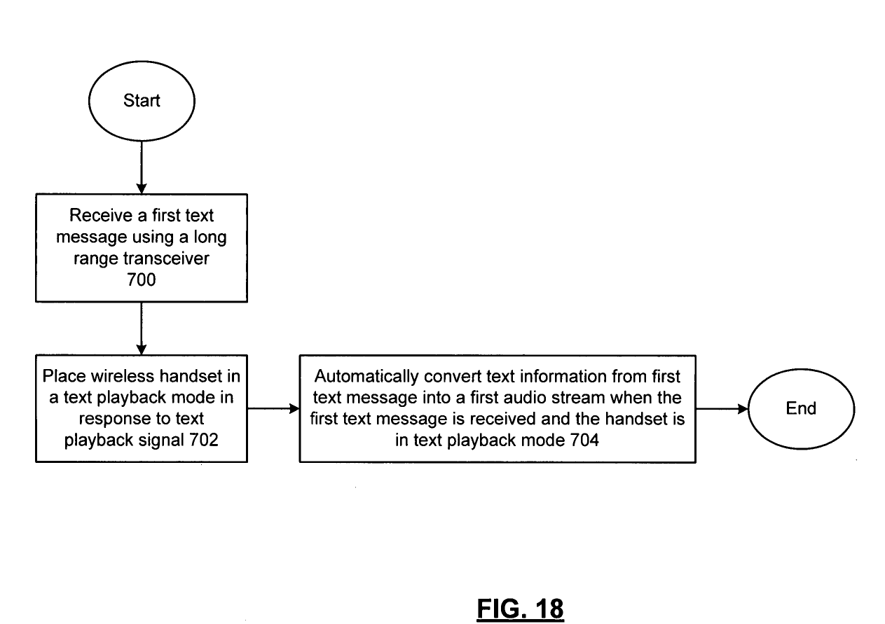

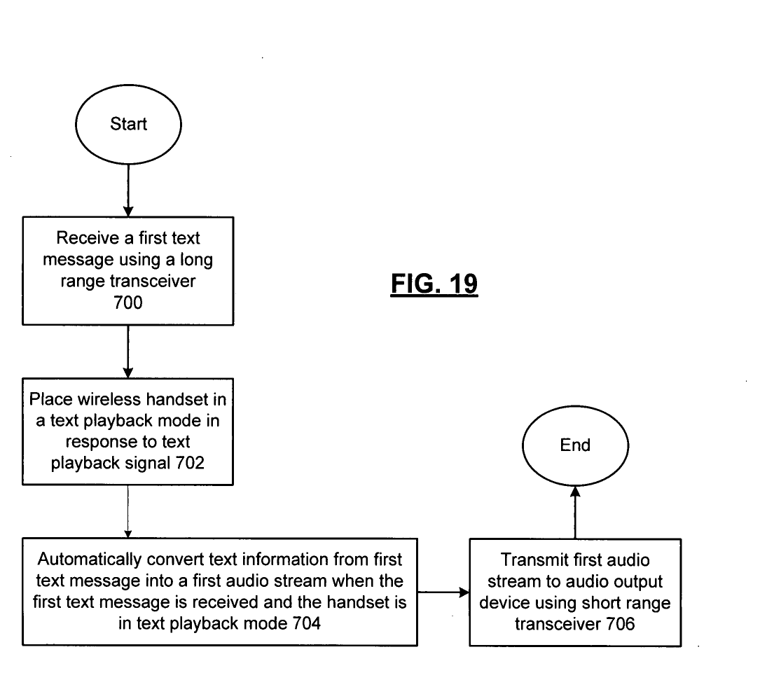

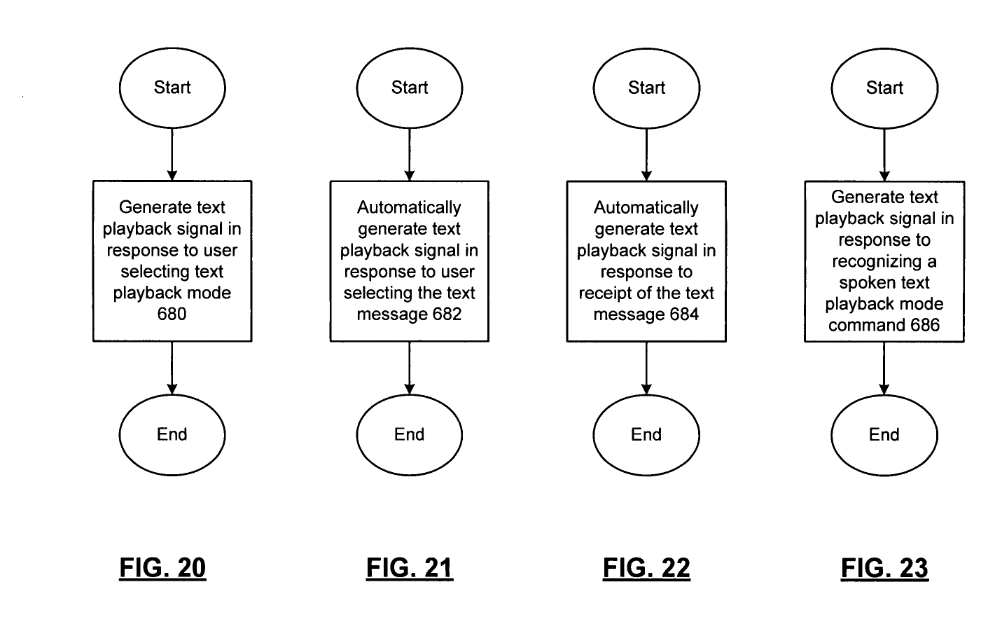

FIGS. 18-23 present flowchart representations of methods in accordance with embodiments of the present invention. In particular, these methods can be used in conjunction with the embodiments of the present invention described in conjunction with FIGS. 1-17. The method begins in step 700 by receiving a first text message using a long range transceiver. In step 702, a wireless handset is placed in an text playback mode in response to a text playback signal. In step 704, text information is automatically converted from the first text message into a first audio stream when the first text message is received and the handset is in the text playback mode and the first audio stream is converted into a first audio output. In a further embodiment, step 706 includes transmitting the first audio stream to the audio output device using a short range wireless transceiver. In addition step 680 includes generating the text playback signal in response to a user selecting the text playback mode, step 682 includes automatically generating the text playback signal in response to a user selecting the first text message, step 684 includes automatically generating the text playback signal in response to the receipt of the first text message, and step 686 includes generating the text playback signal in response to recognizing a spoken text playback mode command of a user.

While the description above has set forth several different modes of operation, the wireless handset 150 may simultaneously be in two or more of these modes, unless, by their nature, these modes necessarily cannot be implemented simultaneously.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

In preferred embodiments, the various circuit components are implemented using 0.35 micron or smaller CMOS technology and can include one or more system on a chip integrated circuits that implement any combination of the devices, modules, submodules and other functional components presented herein. Provided however that other circuit technologies including other transistor, diode and resistive logic, both integrated or non-integrated, may be used within the broad scope of the present invention. Likewise, various embodiments described herein can also be implemented as software programs running on a computer processor. It should also be noted that the software implementations of the present invention can be stored on a tangible storage medium such as a magnetic or optical disk, read-only memory or random access memory and also be produced as an article of manufacture.

Thus, there has been described herein an apparatus and method, as well as several embodiments including a preferred embodiment, for implementing a wireless handset. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A wireless handset comprising:
a long range wireless transceiver for sending and receiving wireless signals to and from a wireless telephone network and for selectively producing a first audio stream;
a host interface for downloading stored audio files from a host device;
an audio playback module for selectively producing a second audio stream from at least one of the stored audio files;
a mixing module, operably coupled to the long range transceiver and the audio playback module, for producing a mixed audio stream when the first audio stream and the second audio stream are produced contemporaneously;
a first audio output device for producing an audio output based on at least one of:
the mixed audio stream, the first audio stream, and the second audio stream; and
a short range wireless transceiver for providing at least one of: the first audio stream, the second audio stream, and the mixed audio stream to a second audio output device.

2. The wireless handset of claim 1 wherein the first audio stream includes one of: a ringtone, a received message indicator and a low battery indicator.

3. The wireless handset of claim 2 wherein the first audio stream includes a query to listen to a received message.

4. The wireless handset of claim 1 wherein the first audio stream includes voice data from a telephone call.

5. The wireless handset of claim 1 wherein the first audio stream includes playback of an audio file from a received message.

6. The wireless handset of claim 1 wherein the first audio stream includes a speech synthesized audio stream from a text file.

7. The wireless handset of claim 6 wherein the text file is derived from a text message.

8. The wireless handset of claim 6 wherein the text file is derived from received caller identification (ID) information.

9. The wireless handset of claim 1 wherein the audio playback module suspends the second audio stream in response to a user selection to accept a call.

10. The wireless handset of claim 9 wherein the audio playback module automatically continues the second audio stream in response to a user selection to end the call.

11. The wireless handset of claim 10 further comprising:
a speech recognition module, operably coupled to the audio playback module, wherein the at least one of: the user selection to end a call, and the user selection to accept a call, includes a spoken command recognized by the speech recognition module.

12. The wireless handset of claim 1 wherein the mixing module attenuates a volume of the second audio stream in response to a user selection to accept a call.

13. The wireless handset of claim 12 wherein the mixing module boosts the volume of the second audio stream in response to a user selection to end the call.

14. The wireless handset of claim 13 further comprising:
a speech recognition module, operably coupled to the audio playback module, wherein the at least one of: the user selection to end a call, and the user selection to accept a call, includes a spoken command recognized by the speech recognition module.

15. The wireless handset of claim 1 further comprising:
a short range wireless transceiver for providing access to a broadband data network.

16. A wireless handset comprising:
a long range wireless transceiver for sending and receiving wireless data to a wireless telephone network and for selectively producing a first audio stream;
an audio playback module for selectively producing a second audio stream from a stored audio file;
a mixing module, operably coupled to the long range transceiver and the audio playback module, for producing a mixed audio stream when the first audio stream and the second audio stream are produced contemporaneously; and
an audio output device for producing an audio output based on at least one of: the mixed audio stream, the first audio stream, and the second audio stream.

17. The wireless handset of claim 16 wherein the first audio stream includes one of: a ringtone, a received message indicator and a low battery indicator.

18. The wireless handset of claim 17 wherein the first audio stream includes a query to listen to a received message.

19. The wireless handset of claim 16 wherein the first audio stream includes voice data from a telephone call.

20. The wireless handset of claim 16 wherein the first audio stream includes playback of an audio file from a received message.

21. The wireless handset of claim 16 wherein the first audio stream includes a speech synthesized audio stream from a text file.

22. The wireless handset of claim 21 wherein the text file is derived from a text message.

23. The wireless handset of claim 21 wherein the text file is derived from received caller identification (ID) information.

24. The wireless handset of claim 16 wherein the audio playback module suspends the second audio stream in response to a user selection to accept a call.

25. The wireless handset of claim 24 wherein the audio playback module automatically continues the second audio stream in response to a user selection to end the call.

26. The wireless handset of claim 25 further comprising:
a speech recognition module, operably coupled to the audio playback module, wherein the at least one of: the user selection to end a call, and the user selection to accept a call, includes a spoken command recognized by the speech recognition module.

27. The wireless handset of claim 16 wherein the mixing module attenuates a volume of the second audio stream in response to a user selection to accept a call.

28. The wireless handset of claim 27 wherein the mixing module boosts the volume of the second audio stream in response to a user selection to end the call.

29. The wireless handset of claim 28 further comprising:
a speech recognition module, operably coupled to the audio playback module, wherein the at least one of: the user selection to end a call, and the user selection to accept a call, includes a spoken command recognized by the speech recognition module.

30. The wireless handset of claim 16 further comprising:
a short range wireless transceiver for providing at least one of: the first audio stream, the second audio stream, and the mixed audio stream to the audio output device.

31. The wireless handset of claim 16 further comprising:
a host interface for downloading the stored audio files from a host device.

32. The wireless handset of claim 16 further comprising:
a short range wireless transceiver for providing access to a broadband data network.

33. The wireless handset of claim 32 further comprising:
a browser for downloading the stored audio files from the broadband data network.

34. A method comprising:
receiving a first audio stream in response to signals from a wireless telephone network;
receiving a second audio stream from a stored audio file; and
producing a mixed audio stream when the first audio stream and the second audio stream are produced contemporaneously.

35. The method of claim 34 wherein the first audio stream includes one of: a ringtone, and a received message indicator.

36. The method of claim 35 wherein the first audio stream includes a query to listen to a received message.

37. The method of claim 34 wherein the first audio stream includes voice data from a telephone call.

38. The method of claim 34 wherein the first audio stream includes playback of an audio file from a received message.

39. The method of claim 34 wherein the first audio stream includes a speech synthesized audio stream from a text file.

40. The method of claim 39 wherein the text file is derived from a text message.

41. The method of claim 39 wherein the text file is derived from received caller identification (ID) information.

42. The method of claim 34 further comprising:
suspending the second audio stream in response to a user selection to accept the call.

43. The method of claim 42 further comprising:
automatically continuing the second audio stream in response to a user selection to end the call.

44. The wireless handset of claim 43 wherein the at least one of: the user selection to end a call, and the user selection to accept a call, includes a spoken command recognized by a speech recognition module.

45. The method of claim 34 further comprising:
attenuating a volume of the second audio stream in response to a user selection to accept the call.

46. The method of claim 45 further comprising:
boosting the volume of the second audio stream in response to a user selection to end the call.

47. The wireless handset of claim 46 wherein the at least one of: the user selection to end a call, and the user selection to accept a call, includes a spoken command recognized by a speech recognition module.

48. The method of claim 34 further comprising:
transferring to an audio output device, at least one of: the first audio stream, the second audio stream and the mixed audio stream.

49. The method of claim 48 wherein the step of transferring to an audio output device includes transmitting at least one of: the first audio stream, the second audio stream and the mixed audio stream to an audio output device using a short range wireless transceiver.

50. The wireless handset of claim 34 further comprising:
downloading the stored audio files from a host device.

51. The wireless handset of claim 34 further comprising:
accessing a broadband data network using a short range wireless transceiver; and
downloading the stored audio files from the broadband data network.
